(19) United States
(12) Patent Application Publication
(10) Pub. No.: US 2013/0242553 A1
(43) Pub. Date: Sep. 19, 2013

(54) OPTICAL LENS AND A LIGHTING ASSEMBLY COMPRISING THE OPTICAL LENS

(71) Applicants: Yaojun Feng, Shenzhen (CN); Nimchung Ku, Shenzhen (CN); Hui Wu, Shenzhen (CN); Canbang Yang, Shenzhen (CN)

(72) Inventors: Yaojun Feng, Shenzhen (CN); Nimchung Ku, Shenzhen (CN); Hui Wu, Shenzhen (CN); Canbang Yang, Shenzhen (CN)

(73) Assignee: OSRAM GMBH, Muenchen (DE)

(21) Appl. No.: 13/989,064

(22) PCT Filed: Nov. 9, 2011
(86) PCT No.: PCT/EP11/69723

§ 371 Date: May 23, 2013

(30) Foreign Application Priority Data
Nov. 29, 2010 (CN) 201010565032.8

(51) Int. Cl. F21V 7/00

(52) U.S. Cl. CPC F21V 7/00
USPC 362/235; 362/335

(57) ABSTRACT

An optical lens may include two sidewall portions arranged opposite to each other; and a midsection connecting the two sidewall portions, the two sidewall portions and the midsection defining a linear concave space accommodating a plurality of light sources in a linear arrangement, the midsection including a light input surface facing toward the light sources and a light output surface facing away from the light sources, the sidewall portions including a reflective surface which can totally reflect at least part of light.

### RELATED APPLICATIONS

The present application is a national stage entry according to 35 U.S.C. §371 of PCT application No.: PCT/EP2011/069723 filed on Nov. 9, 2013, which claims priority from Chinese application No.: 2010 105 650 32.8 filed on Nov. 29, 2010.

### TECHNICAL FIELD

Various embodiments relate to an optical lens and also relate to a lighting assembly comprising the optical lens.

### BACKGROUND

In the linear light fixture in the prior art, in order to get the waterproof effect, a cover plate is often used to encapsulate the aluminum frame. A plurality of light sources are enclosed in the whole aluminum frame. The drawback of this method is that the light loss is as high as the LED is arranged in the aluminum frame even if the aluminum is polished or provided with a reflective coating (see FIG. 1). In the linear light fixture in the prior art, in order to avoid the light loss, a plurality of light sources are usually provided in a linear arrangement to form respective lighting modules, and each light source is provided with a corresponding optical lens thereon to avoid light loss and re-distribute light. Thereafter, a plurality of lighting modules are encapsulated. The drawback of such linear light fixture is complex in assembling (see FIG. 2).

### SUMMARY

Various embodiments provide an optical lens suited to the linear light fixture to overcome the drawback in the prior art. This optical lens can reduce the light loss to the lowest and re-distribute light, and also has the advantage of easy assembling. Various embodiments further provide an optical lens that can lay a good foundation for providing a linear light fixture with favorable waterproof performance. Various embodiments provide a lighting assembly with favorable waterproof performance comprising the above optical lens.

Various embodiments provide following solution: an optical lens, characterized by comprising two sidewall portions arranged opposite to each other and a midsection connecting the two sidewall portions, wherein the two sidewall portions and the midsection define a linearly extending concave space for accommodating a plurality of light sources in a linear arrangement, the midsection comprises a light input surface facing toward the light sources and a light output surface away from the light sources, the sidewall portions comprises a reflective surface which can totally reflect at least part of light. By enclosing a plurality of light sources in a linear arrangement with an optical lens therein, firstly, the assembling can be simplified as a plurality of light sources can commonly use one lens for light distribution; secondly, by enclosing the light sources by the sidewall portions and the midsection therein and the midsection comprising the light input surface facing toward the light source and the light output surface facing away from the light source, the light emitted from the light sources can go through the light input surface of the midsection and output from the light output surface or go through the inner walls of the sidewall portions facing toward the light sources and at least partly totally reflected and can be further output from the light output surface, thus, it can avoid the light loss in the prior art in which the cover plate is used.

According to a preferred solution of various embodiments, the light input surface of the midsection is an inner concave curved surface. Consequently, the expected light output can be obtained by adjusting the profile of the light input surface.

According to a preferred solution of various embodiments, the light output surface of the midsection has a middle region with a bending concave and border regions with a bending convex at both sides of the middle region so as to obtain the expected light output. Preferably, the curvature of the border region of the light output surface is greater than that of the middle region. According to the different design requirement, by configuring the light output surface, a part of the light input through the light input surface can be refracted to deviate from or approach to the primary direction of the light sources. Thereby, the illuminance area on a plane provided perpendicular to the primary direction of the light sources and spaced from the light output surface behind the lens is enlarged or decreased.

According to a preferred solution of various embodiments, the primary direction of the light sources runs through the middle region of the light output surface and the border regions are symmetrically arranged at both sides of the middle region. Therefore, the light output forming an angle with the primary direction of the light sources and output from the light output surface is enhanced and the illuminance area of the light sources is enlarged.

Preferably, the light input surface is a free-form curved surface. And preferably, the light output surface is described by the polynomial z(x)=4(x/10)2−36(x/10)4, wherein z is parallel to the direction of the primary direction of the light sources.

Preferably, the optical lens is made of a soft material such as PA, PVC, TPU, silicon so that the desired size can be easily obtained by cutting. And preferably, the middle portion and sidewall portions are fabricated in one piece through a protrusion process so as to be manufactured highly effectively.

Various embodiments still further provide a lighting assembly correspondingly. The lighting assembly comprises: an optical lens having the above features; a plurality of light sources accommodated in a linear concave space of the optical lens; a circuit board bearing a plurality of light sources; and a frame, preferably made of metal, supporting the circuit board and protruding outwardly from both sides of the circuit board. Correspondingly, the lighting assembly according to the various embodiments also has the effects of low light loss and easy assembling, and lays a good foundation for providing a lighting assembly with favorable waterproof performance. In various embodiments, the frame may be made of metal or any other material with good thermal conductivity and high mechanical resistance. Good thermal conductivity is assumed to be higher than 20 W/Mk, preferably higher than 100 W/Mk.

Various embodiments further provide a lighting assembly with good waterproof performance, wherein an encapsulation part is provided in a space between the lens and the frame to encapsulate the space between the lens and the frame so as to realize good water resistance. Further, encapsulation glue is provided in the space between the lens and the frame for further improving the water resistance.

The lens according to various embodiments has the advantages of low light loss and easy assembling, and lays a good foundation for providing a linear light fixture with favorable waterproof performance. The lighting assembly according to various embodiments has the advantages of low light loss and easy assembling, and has good waterproof performance.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIGS. 1 and 2 illustrate two solutions of the linear light fixture in the prior art;

FIG. 3 illustrates a view of a lens according to the disclosed embodiments;

FIGS. 4A and 4B illustrate views of a lighting assembly after being mounted with a lens according to the disclosed embodiments;

FIGS. 5A to 5F illustrate comparative views of light path, light distribution and optical efficiency of the lighting assembly according to the lighting assembly in the prior art (FIGS. 5A to 5C) and the disclosed embodiments (FIGS. 5D and 5F); and

FIGS. 6 and 7 illustrate views of the lighting assembly with a waterproof structure according to the disclosed embodiments.

### DETAILED DESCRIPTION

The following detailed description refers to the accompanying drawings that show, by way of illustration, specific details and embodiments in which the disclosed embodiments may be practiced.

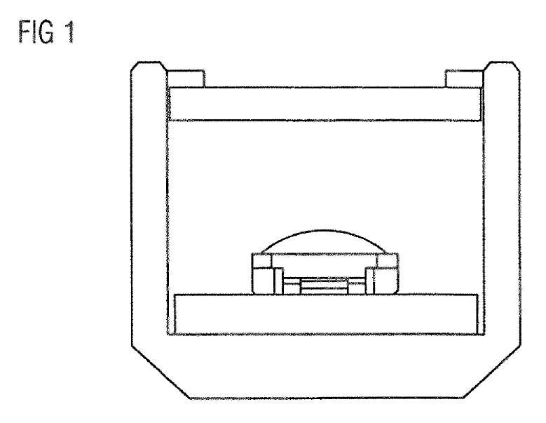

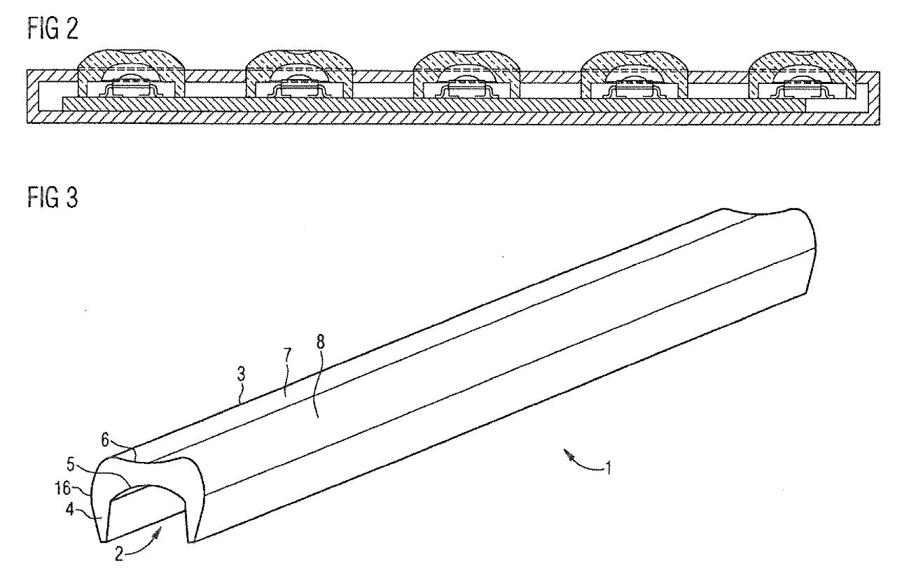

FIGS. 1 and 2 illustrate two solutions of the linear light fixture in the prior art, respectively. As described above, the light loss in FIG. 1 is quite high, and the assembly in FIG. 2 is quite complex.

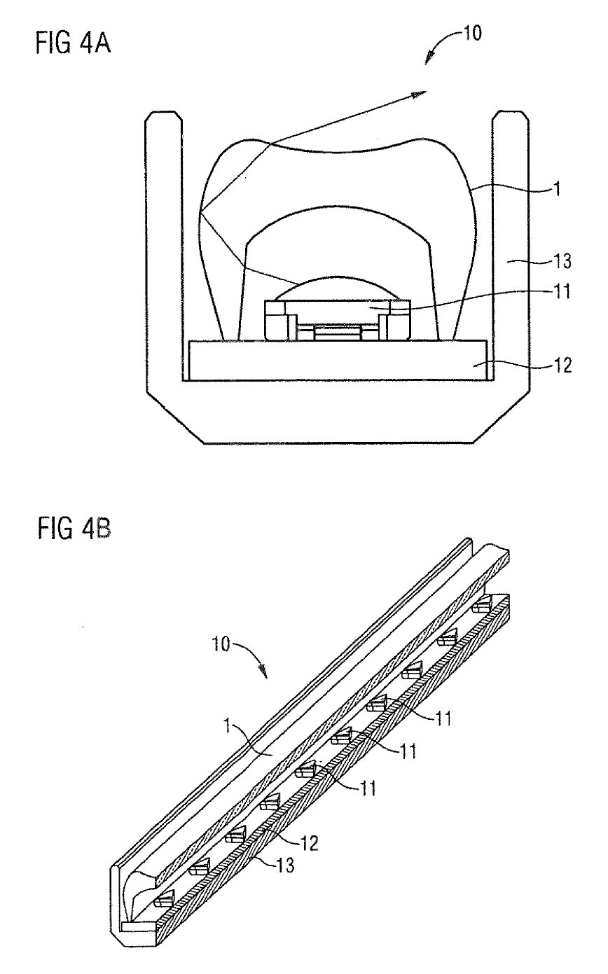

FIG. 3 illustrates a view of a lens 1 according to various embodiments. The lens 1 according to various embodiments is linearly designed. Correspondingly, the lens 1 according to various embodiments is provided with a linear concave space 2 for accommodating a plurality of light sources in a linear arrangement (not shown in FIG. 3) therein. The linear extending lens 1 according to various embodiments comprises a midsection 3 and two sidewall portions 4. The midsection 3 is connected with the two sidewall portions 4 with an opening as the linear concave space 2 above formed, consequently, a plurality of light sources 11 are placed within the lens 1.

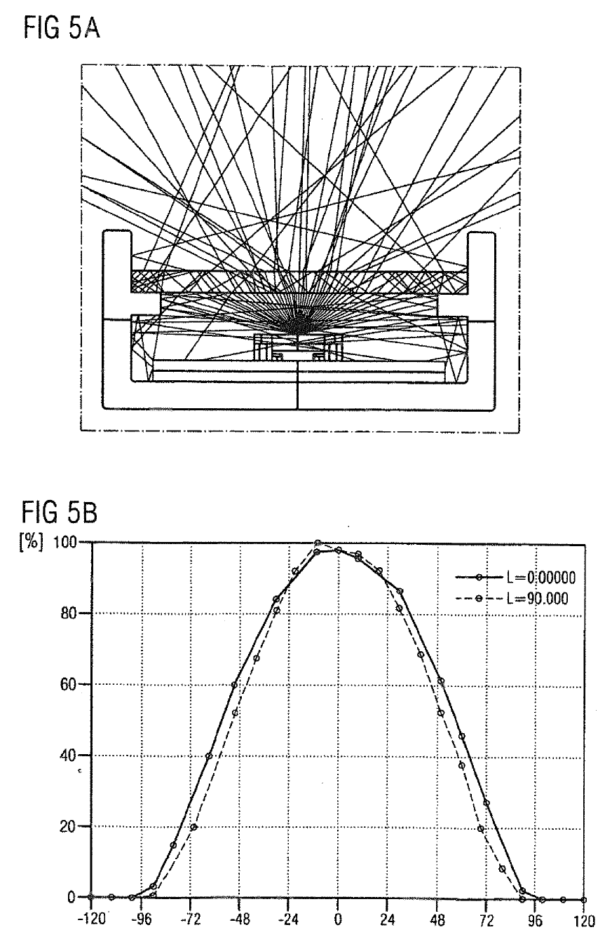

The midsection 3 of the lens 1 comprises a light input surface 5 located inside and facing toward the light source side and a light output surface 6 located outside and facing away from the light source. Of course, the inner-wall portion of the sidewall portion 4 also is used as the light input surface. The sidewall portions 4 comprises a reflective surface 16 which can totally reflect at least part of light. The light emitted from the light sources can go through the light input surface 5 of the midsection and output from the light output surface 6 or go through the inner walls of the sidewall portions 4 facing toward the light sources 11 and at least partly totally reflected and then can be further output from the light output surface 6. The light is incident through the light input surface and emitted after being refracted, (see FIG. 4a, 5d) In order to obtain larger outgoing scope deviating from the primary direction of the light sources and to obtain ideal light distribution pattern, the configurations of the light input surface 5 and the light output surface 6 as well as the distance of the sidewall portions 4 from the primary direction of the light sources can be correspondingly adjusted. In this embodiment, the light input surface 5 is designed to be an inner concave curved surface. The light input surface 5 can be a free curved surface or other suitable curved surface. And the light output surface 6 has a middle region 7 with a bending concave and border regions 8 at both sides of the middle region 7. The curvature of the border region of the light output surface 6 is greater than that of the middle region 7. The primary direction of the light sources runs through the middle region 7 of the light output surface 6 and the border regions 8 are symmetrically arranged at both sides of the middle region 7. The light output surface also can be described by the polynomial z(x)=4(x/10)²−36(x/10)4, wherein z is parallel to the direction of the primary direction of the light sources.

The lens 1 itself can be fabricated in one piece that may be made of a soft material such as PA, PVC, TPU, silicon by a protrusion method, thus, any desired size can be obtained by cutting.

FIGS. 4A and 4B illustrate views of a lighting assembly after being mounted with a lens according to various embodiments. A lighting assembly 10 in various embodiments comprises the lens according to various embodiments as described in the preceding. As shown in the figures, a plurality of light sources 11 are accommodated in a linear concave space 2 of the optical lens 1. The lighting assembly 10 further comprises a circuit board 12 bearing a plurality of light sources 11; and a frame 13 supporting the circuit board 12 and protruding outwardly from both sides of the circuit board 12. As the lighting assembly 10 in various embodiments does not need the cover plate in the prior art, but uses the linear lens 1 directly for a plurality of light sources 11, the assembling becomes easy while the light loss is decreased. From the light path shown in FIG. 4A it can be seen that the light is inputted onto the lens 1 and goes out through the light output surface of the midsection of the lens 1 after being reflected and refracted.

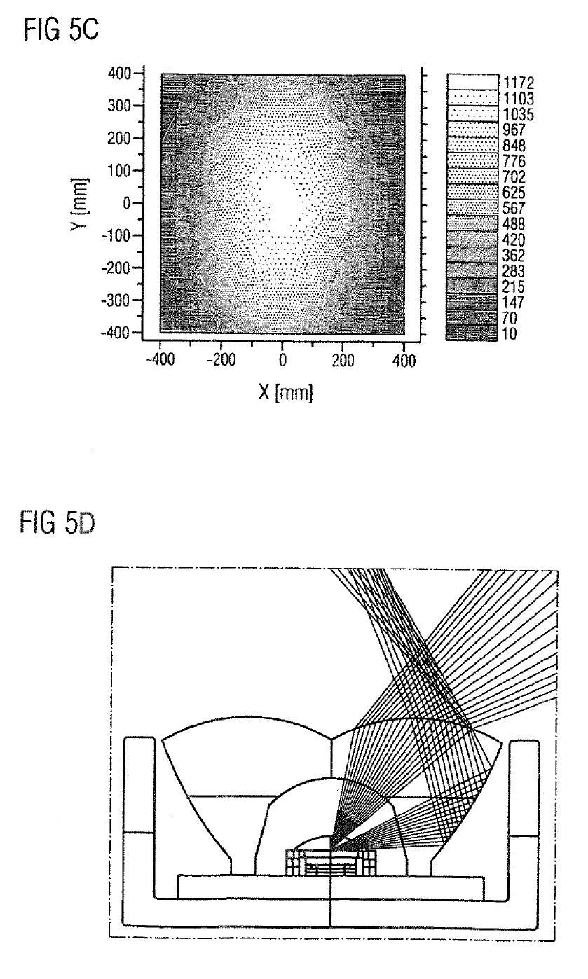

FIGS. 5A to 5F illustrate comparative views of light path, light distribution and optical efficiency of the lighting assembly according to the lighting assembly in the prior art (FIGS. 5A to 5C) and disclosed embodiments (FIGS. 5D and 5F). From the figures it can be seen that the light loss is quite low after the light passes through the lens in various embodiments, and the light distribution effect is quite good with an optical efficiency reaching 80%. The light emitted from the light sources can go through the light input surface 5 of the midsection and output from the light output surface 6 or go through the inner walls of the sidewall portions 4 facing toward the light sources 11 and at least partly totally reflected by reflective surface 16 and then can be further output from the light output surface 6.

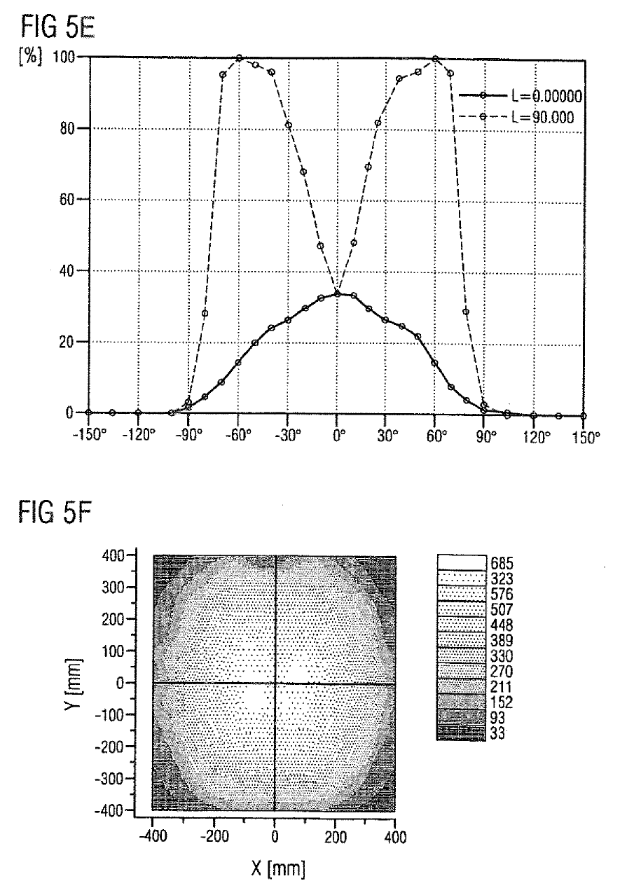

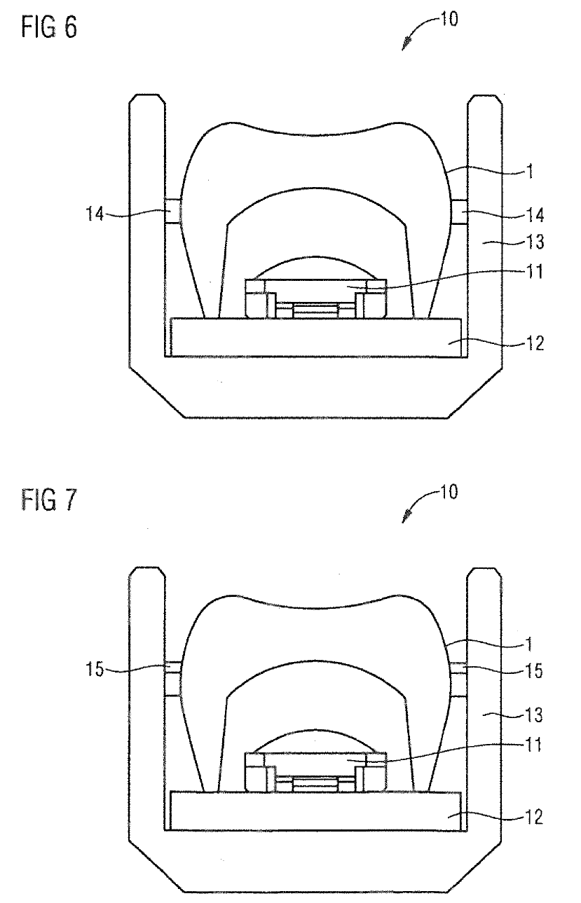

FIGS. 6 and 7 illustrate views of the lighting assembly with a waterproof structure according to various embodiments. From FIG. 6 it can be seen that an encapsulation part 14 is provided in a space between the lens 1 and the frame 13 to encapsulate the space between the lens 1 and the frame 13. Further as shown in FIG. 7, encapsulation glue 15 is further added thereto to be potted into the space between the lens 1 and the frame on the encapsulation part 14 so as to obtain further waterproof effect.

While the disclosed embodiments has been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

List of reference signs

1 lens

2 linear concave space

3 midsection

4 sidewall portion

5 light input surface

6 light output surface

7 middle region

8 border region

10 lighting assembly

11 light source

12 circuit board

13 frame

14 encapsulation part

15 encapsulation glue

16 reflective surface

1. An optical lens, characterized by comprising two sidewall portions arranged opposite to each other; and a midsection connecting the two sidewall portions, the two sidewall portions and the midsection defining a linear concave space accommodating a plurality of light sources in a linear arrangement, the midsection comprising a light input surface facing toward the light sources and a light output surface facing away from the light sources, the sidewall portions comprising a reflective surface which can totally reflect at least part of light.

2. The optical lens according to claim 1, wherein the light input surface of the midsection is an inner concave curved surface.

3. The optical lens according to claim 1, wherein the light output surface of the midsection has a middle region with a bending concave and border regions with a bending convex at both sides of the middle region.

4. The optical lens according to claim 3, wherein a curvature of the border region of the light output surface is greater than that of the middle region.

5. The optical lens according to claim 3, wherein primary direction of the light sources runs through the middle region of the light output surface and the border regions are symmetrically arranged at both sides of the middle region.

6. The optical lens according to claim 1, wherein the light input surface is a free curved surface.

7. The optical lens according to claim 1, wherein the light output surface is described by a polynomial z(x)=4(x/10)²−36(x/10)⁴, wherein z is parallel to a direction of the primary direction of the light sources.

8. The optical lens according to claim 1, wherein the reflective surface of the each sidewall portions is outer surface of each sidewall portions.

9. The optical lens according to claim 1, wherein the midsection and the sidewall portions are made of one of soft material group comprising PA, PVC, TPU, silicon.

10. The optical lens according to claim 1, wherein midsection and the sidewall portions are fabricated in one piece through a protrusion process.

11. A lighting assembly, comprising: an optical lens comprising two sidewall portions arranged opposite to each other; and a midsection connecting the two sidewall portions, the two sidewall portions and the midsection defining a linear concave space accommodating a plurality of light sources in a linear arrangement, the midsection comprising a light input surface facing toward the light sources and a light output surface facing away from the light sources, the sidewall portions comprising a reflective surface which can totally reflect at least part of light; a plurality of light sources accommodated in a linear concave space of the optical lens; a circuit board bearing the plurality of light sources; and a frame supporting the circuit board and protruding outwardly from both sides of the circuit board.

12. The lighting assembly according to claim 11, wherein an encapsulation part is provided in a space between the optical lens and the frame to encapsulate the space between the optical lens and the frame.

13. The lighting assembly according to claim 12, wherein encapsulation glues provided in the space between the optical lens and the frame.
